(19) United States
(12) Patent Application Publication
(10) Pub. No.: US 2018/0026459 A1
(43) Pub. Date: Jan. 25, 2018

(54) INSERT FOR BAG FOR HOLDING AND CHARGING ELECTRONIC DEVICES ON THE GO

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 15/253,684

(22) Filed: Aug. 31, 2016

Related U.S. Application Data
(63) Continuation-in-part of application No. 15/216,696, filed on Jul. 22, 2016.

(51) Int. Cl. H02J 7/00; A45C 13/02; A45C 11/00; A45C 15/06

(52) U.S. Cl. CPC H02J 7/0044; H02J 7/0021; A45C 15/06; A45C 13/02; A45C 11/00; A45C 2011/002

(57) ABSTRACT

An insert for a travel bag is used for travelling with electronic devices and charging them on the go. It is designed for convenience. It holds a traveller's items, including a mobile phone and camera. It helps store the traveller's items safely, conveniently and also helps charge them. It is made of strong material to provide slash resistance, durability and ease of mind during travel.

### CROSS REFERENCES TO RELATED APPLICATIONS

The present patent application is a continuation-in-part (CIP) of, claims priority to, and makes reference to U.S. non-provisional patent Ser. No. 15/216,696 filed on 22-Jul.-2016, entitled “BAG FOR HOLDING TRAVEL ITEMS, DESIGNED FOR CONVENIENCE”, docket number SEKURT-01.

### BACKGROUND

### 1. Technical Field

The present invention relates generally to bags used to carry items for travel, and specifically to bags that carry travel items and electronic devices.

### 2. Related Art

People have been travelling for ages. Travel for fun or for business has become a common activity. People of late have been carrying mobile phones with them, often taking their mobile phone chargers with them. Similarly, most travellers carry cameras and camcorders with them on their journey, and they pack additional chargers for those cameras and camcorders. When a person travels abroad, that person often takes power adapters with them, and quite often several different power adapters, one for each electrical device, such as the mobile phone, the camera, the hair dryer, etc. These plethora of chargers, cables, power adapters, one for each electrical device packed by the traveller, add to the complexity of packing for a trip, and add to the total luggage weight.

Often, a traveller unpacks all his electrical devices at the end of a day of travel, and back at the hotel, in order to charge them for the next day of use. This involves locating several different power outlets, one for each electrical device to be charged, and then bringing out the charging cables, hooking them up to the electrical devices, and plugging the other end of the charging cables into power adapters (as necessary) before plugging the power adapters into wall sockets. This rigmarole is repeated in revers order the next day in the morning to repack all those cables, the plurality of power adapters, the wall sockets, and the devices. Often a traveller forgets to repack some of those cables, power adapters and devices, only to realize much later that those items have been left behind at the hotel.

Pickpocketing is a problem in quite a few places where people tend to visit. Pickpockets can be found in several cities and even in rural places all over the world, and losses due to theft are quite devastating to some travellers. For example, a pickpocket may cut open a traveller's bag and steal a purse full of cash and credit cards without the traveller discovering the loss much later. Thieves have been known to slash bags even without the traveller noticing such activities, or realizing that her belongings are being stolen.

People who carry electronic devices have to dump them in their travel bags wherever there is some space available, often scratching them up, and having them damaged due to frequent jostling with other travel items.

There is a need for better bags that are more secure, and more convenient. There is a need for bags that provide the user the ability to easily handle unpacking and repacking at hotels.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of an insert for a travel bag/luggage bag that stores travel items, wherein the insert comprises a plurality of sides (such as two sides—side A and side B), wherein the sides comprise pockets/pouches to house electronic devices that need charging;

FIG. 2 is a perspective block diagram of an insert for a travel bag/luggage bag that stores travel items, wherein the insert comprises a plurality of sides, wherein the sides comprise pockets/pouches to house electronic devices that need charging, wherein the electronic devices are connected to a power bank charger device in one of the pockets/pouches by means of power cables that are passed through guiding channels;

FIG. 3 is a perspective diagram of a bag comprising an outer enclosure member (which has multiple inner regions) including inwardly facing walls defining a compartment, and a removable, second inner member (an insert) having a first side and a second side the first side comprising a first pouch to house a power bank charger, a second pouch to house a mobile device connected to the power bank charger employing a first cable, and a third pouch to house a camera connected to the power bank charger employing a second cable;

FIG. 4. is a perspective block diagram of another bag for travel items which provides a first insert to hold electronic devices that are charged by a power bank charger, and a second insert which provides pouches for pens and pencils, keyring and a zippered EMF protected pocket for safely storing credit cards and passports; and

FIG. 5 is a perspective block diagram of an exemplary insert which provides pouches/pockets, for pencils and pens, a keyring to hold keys, and a zippered EMF protected pocket for safely storing credit cards and passports.

### DETAILED DESCRIPTION OF THE DRAWINGS

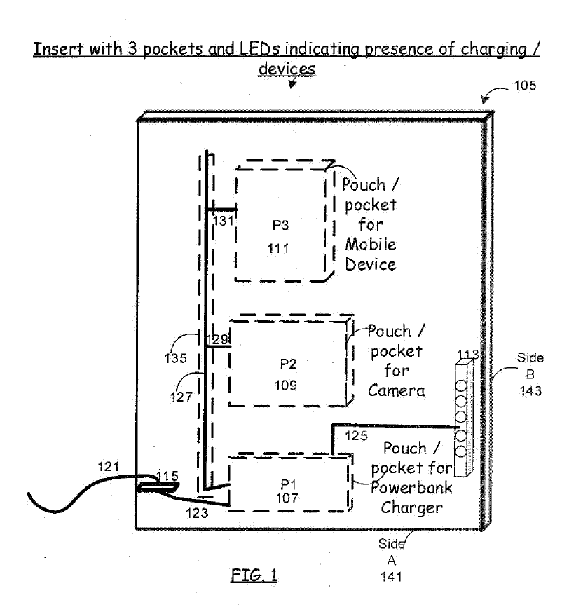

FIG. 1 is a perspective block diagram of an insert 105 for a travel bag/luggage bag that stores travel items, wherein the insert 105 comprises a plurality of sides (such as two sides—side A 141 and side B 143), wherein the sides comprise pockets/pouches to house electronic devices that need charging. The bag where this insert is used comprises a plurality of walls wherein those constituting the outer walls comprise a slash resistant material layer. Thus, the items inside the luggage bag are not easy to steal by pickpockets and thieves who often try to silently make a cut or tear in the bag without the traveller/user noticing it. The insert 105 also comprises a first wall/side A 141 among the plurality of walls along which a first holder 107 (pocket or pouch, for example) for a powerbank portable charging device is provided, wherein the powerbank portable charging device supplies power from its built-in batteries through a plurality of USB ports (for example) to other electronic devices such as a camera or mobile device.

The insert 105 also comprises a second holder 111 for a mobile device, and a third holder 109 for a camera. The second holder 111 and third holder 109 are in proximity to the first holder 107, in a configuration that minimizes the distance between them. For example, second holder 111 and third holder 109 are each within 2 inches of the first holder 107, in one configuration (with the first holder 107 between the other two holders, for example), making them close enough to connect to their respective devices (that are housed in those holders) to the powerbank portable charging device employing a very short power cable, such as a USB power cable, for example of about 3 inches or so. The very short power cables are attached to the corresponding walls, in a related embodiment, using glue or stitches or guiding channels 135.

The insert 105 for the luggage bag also comprises a USB outlet 115 on one of the walls (side A 141 for example) for a power cable connection to the powerbank portable charging device located in the first holder 107. The USB outlet 115 makes it possible to pass a USB power charging cable 121 out of the bag towards a USB based power outlet, for providing power to the powerbank portable charging device housed in the holder (pocket or pouch) 107.

In one configuration, the insert 105 also comprises a pocket for credit cards, to hold a plurality of credit cards. The pocket in a related embodiment comprises a plurality of slots for credit cards, for housing each credit in its own slot inside the pocket.

In one embodiment, power cables 131, 129 connect an electronic device to the power bank charging device housed in the pocket 107 by attaching to a nearest power bus 127 in proximity. Other types of power connections using power cables 131 and 129 are also contemplated.

In a related embodiment, the pocket for credit cards comprises walls with an electromagnetic field (EMF) blocking material layer. In another embodiment, the pocket is large enough to house not only credit cards but also small electronic devices, such as a small mobile phone.

In one configuration of the insert 105, a first USB power charging cable 127/131 leading from the first holder 107 to the second holder 111, and a second USB power charging cable 127/129 leading from the first holder 107 to the third holder 109, are provided. In a related configuration, the first USB power charging cable 127/131 and the second USB power charging cable 127/129 are both physically attached to the associated ones of the sides (such as side A 141 or side B 143).

In one embodiment, the holders 107, 109, 111 are elastic bands that help secure corresponding devices housed in them. In another embodiment, the holders 107, 109, 111 are pockets, and in another related embodiment, the holders 107, 109, 111 are pockets with zippers that securely house any electrical or non-electrical devices placed inside.

The insert 105 now makes it possible to
Charge electrical devices on the go, as they are securely housed in pockets in the bag and the powerbank portable charging device provides recharge capabilities even when mobile (in trains, planes, running etc.)
Security and safety provided—Slash resistant bags which pickpockets and thieves will find very hard to slash, cut, etc. to steal items inside
RFID and credit card safe—EMF protection to make sure identity thieves and credit card thieves do not get hold of digital data in credit cards, passports and identity cards
In addition, in some embodiments, the pockets are made of anti-bacterial and anti-microbial material, such that bacteria, mold and fungus does not grow in pockets, even in places where humidity is relatively high.

In one embodiment, side B 143 also comprises one or more pouches, with electrical power cables provided to devices housed in those pouches, the electrical power cables providing power from any power bank charging device housed in the pouch 107 on side A 141 of the insert.

The insert 105 for a bag holds multiple electronic devices, and in one embodiment, the insert comprises a first side 141 having a first pouch 107 to house a power bank charger, a second pouch 111 to house a first electronic device connected to the power bank charger employing a first cable 131, and a third pouch 109 to house a second electronic device connected to the power bank charger employing a second cable 129. The insert 105 also comprises a first guiding channel 135 that positions the first cable 131 on the first side 141 from the first pouch 107 to the second pouch 111, a second guiding channel 135 that positions the second cable 129 on the first side 141 from the first pouch 107 to the third pouch 111.

A power bank charger cable 123 connects the power bank charger to an external power source when plugged. A plurality of LED lights arranged in a LED display 113, wherein each of the plurality of LED lights when lit indicate the active presence of a corresponding ones of the electronic devices in power sharing coupling with the power bank charger. In one related embodiment, of the electronic devices housed in the insert 105 is a mobile device in the second pouch 111, a camera in the third pouch 109, or another electronic device (such as an MP3 player, a video console, a tablet device, etc.) coupled to the power bank charger for charging.

In a related embodiment, the insert 105 wherein the insert is anchored to the bottom of the bag. The first pouch 107, the second pouch 111 and the third pouch 109 are each zippered pockets with outlets for corresponding connectors and cables.

In another related embodiment, the insert 105 is configured such that the position and a location of the first pouch 107, the second pouch 111 and the third pouch 109 are reconfigurable on the first side 141.

A bag may employ multiple inserts 105 if necessary, perhaps in different regions of the bag. In one embodiment, multiple inserts share one single power bank charging device, with a special power cable supplying power from one with the power bank charging device to the other. In one embodiment, instead of a power bank charging device charging all electronic devices simultaneously, electronic devices are charged one at a time based on a priority (that may be user specified or default).

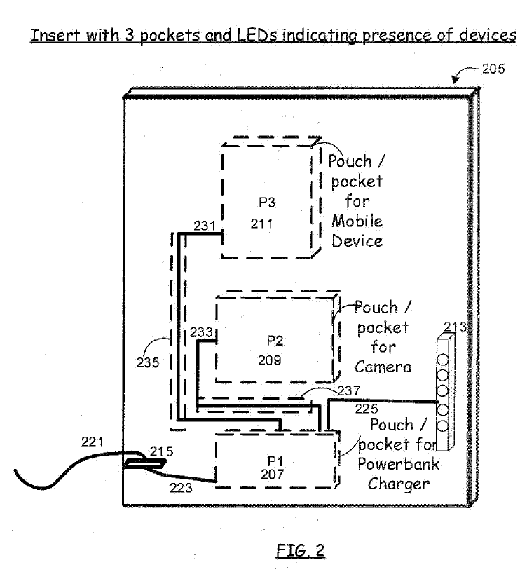

FIG. 2 is a perspective block diagram of an insert 205 for a travel bag/luggage bag that stores travel items, wherein the insert 205 comprises a plurality of sides, wherein the sides comprise pockets/pouches to house electronic devices that need charging, wherein the electronic devices are connected to a power bank charger device in one of the pockets/pouches by means of power cables that are passed through guiding channels 235, 237. For example, a power charging cable 231 passes through a guiding channel 235 to connect a mobile device in a pocket/pouch 211 to a power bank charging device housed in a pouch/pocket 207. Similarly, a power charging cable 233 passes through a guiding channel 237 to connect a camera in a pocket/pouch 209 to the power bank charging device housed in the pouch/pocket 207. Thus a camera in the pocket/pouch 209 and the mobile device in the pocket/pouch 211 are both simultaneously charged by a power bank charging device housed on the pouch/pocket 207 (when those electronic devices are connected respectively to the power bank charging device by their respective power cables). An LED display 213 with a set of individual LEDs indicates which electronic device is currently being charged by the power bank charging device. In addition, the camera in the pocket/pouch 209 and the mobile device in the pocket/pouch 211 are both simultaneously charged on a priority basis (one of them has a higher priority for example) by a power bank charging device housed on the pouch/pocket 207, in one related embodiment. Note that priority can be determined based on the available power levels in each of the electronic devices, based on the device types, and based on time of day, for example. Other criteria for establishing charging priorities are also contemplated.

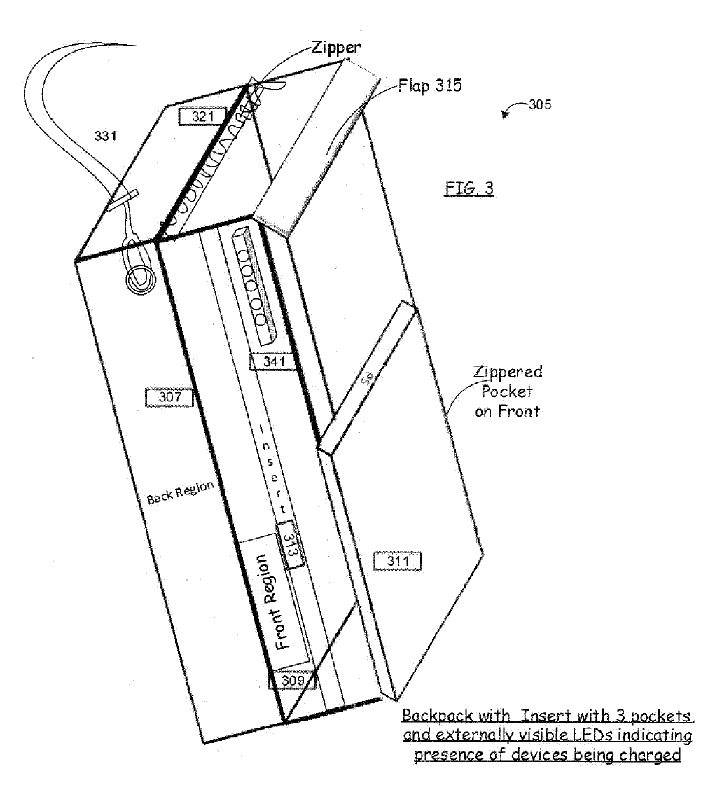

FIG. 3 is a perspective diagram of a bag 305 comprising an outer enclosure member (which has multiple inner regions) including inwardly facing walls defining a compartment, and a removable, second inner member (an insert 313) having a first side and a second side the first side comprising a first pouch to house a power bank charger, a second pouch to house a mobile device connected to the power bank charger employing a first cable, and a third pouch to house a camera connected to the power bank charger employing a second cable. The bag 305 comprises a front region 309 and a back region 307, and the second inner member/insert 313 is selectively placed/housed in the front region 309 or the back region 307, based on user preference. The bag 305 comprises attachment means mounted on said inwardly facing walls of a region, and said inner second member providing selective securement of said second member at a plurality of locations within said enclosure member.

In one embodiment, the second member comprises a bottom, wherein the bottom is collapsible, longitudinally, laterally and diagonally.

The first cable and the second cable on the removable, second inner member (insert 313) are each disposed on and attached to respective retaining means on the first side of the second inner member such that they are attachable at both ends to respective electronic devices.

In one configuration, the first cable and the second cable are disposed inside guiding channels on the first side of the second inner member such that they are positioned close to the first side while also being attachable at both ends to respective electronic devices. The first cable and the second cable are held in those guiding channels so that they do not get entangled with each other or with the fingers of a user.

In a related configuration, the removable, second inner member 313 comprises guiding channels through which the first cable and the second cable are disposed on the first side of the second inner member such that they are positioned close to the first side while also being attachable at both ends to respective electronic devices. For example, the ends of the first and second cables comprise USB male and USB female connectors so that they can be plugged into USB based electronic devices—for power charging or for data sharing purposes or for both.

A plurality of LED lights arranged in a LED display 341 on the second inner member/insert 313, provide information to user on which electronic devices (camera, mobile device, etc.) are currently being charged, or are currently present in their respective holders. Each of the plurality of LED lights when lit indicate the active presence of a corresponding electronic device in power sharing coupling with the power bank charger, wherein the corresponding electronic device is the mobile device in the second pouch, the camera in the third pouch, or another electronic device coupled to the power bank charger for charging. In another related configuration, the LED display 341 is disposed on the outer enclosure member.

Thus the insert/second inner member 313 provides a multi-pocket additional accessory for a travel bag. In one embodiment, the multi-pocket insert 313 for the travel bag 305 comprises a first pocket along the first edge for storing a powerbank charging device, and a second pocket along a second edge in relative proximity to the first pocket, wherein the second pocket is configured to hold a mobile device. It also comprises a third pocket along the third edge in relative proximity to the first pocket, wherein the third pocket is configured to hold one of a camera and a camcorder, and a card holding detachable inner bag is provided wherein the card holding detachable inner bag is configured to hold a plurality of credit cards and identity cards, the card holding detachable inner bag comprising a zippered opening section at the top, and walls made with EMF blocking material. The card holding detachable inner bag comprises slots to hold the credit cards and identity cards, one card per slot.

In one configuration, multi-pocket travel bag 305 further comprises slash resistant capabilities—the exterior walls/panels each comprising a layer of slash resistant fabric. In another related configuration, the layer of slash resistant fabric comprises one or more layers of Kevlar-based fabric. In yet another configuration, layer of slash resistant fabric comprises one or more of a Nomax aramid fabric, a nylon based fabric, a denier based fabric, or a combination thereof.

The multi-pocket travel bag 305 comprises, in one configuration, a cable entry slot close to the insert 313 for passing a cable from an external power outlet or device to the powerbank charging device.

The insert 313, in another configuration, is configured to simultaneously hold in their respective pockets the powerbank charging device, the mobile device and the camera or camcorder, even as the powerbank charging device in the first pocket is used to simultaneously charge the mobile device in the second pocket and the camera or camcorder in the third pocket.

In one configuration, the power outlet is connected to the power charging socket of the insert 313 by means of a charging cable, while the powerbank charging device is electrically connected to the power charging socket inside the bag. In a related configuration, the power charging socket is a USB based socket, to which the powerbank charging device is electrically connected via an appropriate USB cable, to enable connection to an external power outlet or device employing a USB based power charging cable.

A method of charging mobile devices in a travel bag, comprises inserting a bag insert into a travel bag, wherein bag insert comprises a first side having a first pouch to house a power bank charger, a second pouch to house a mobile device connected to the power bank charger employing a first cable, and a third pouch to house a camera connected to the power bank charger employing a second cable. Charging mobile devices also comprises housing a power bank charger in the third pouch, a mobile device in the first pouch connected to the power bank charger by the first cable, and a camera in the second pouch connected to the power bank charger by the second cable.

The method also involves connecting a power bank charger cable to a USB based power outlet at a first end, and to the USB based power connection on the power bank charger at a second end. The USB based power outlet is a wall power socket in one embodiment, a vehicle based power charger outlet in another related embodiment, and a computer with USB power outlet in a different embodiment.

The bag insert comprises a set of LEDs that are lit to indicate the charging of a corresponding electronic device by the power bank charger. The bag insert comprises an audio alert component that beeps when it determines one of the electronic devices have been removed from the bad for a threshold duration. The mobile device and the camera are charged by the power bank charger based on a priority of charging and based on a current charge level determined for each of the mobile device and the camera.

In one related embodiment, a second side of the bag insert provides a third pouch to house an electronic tablet device connected to the power bank charger employing a third cable.

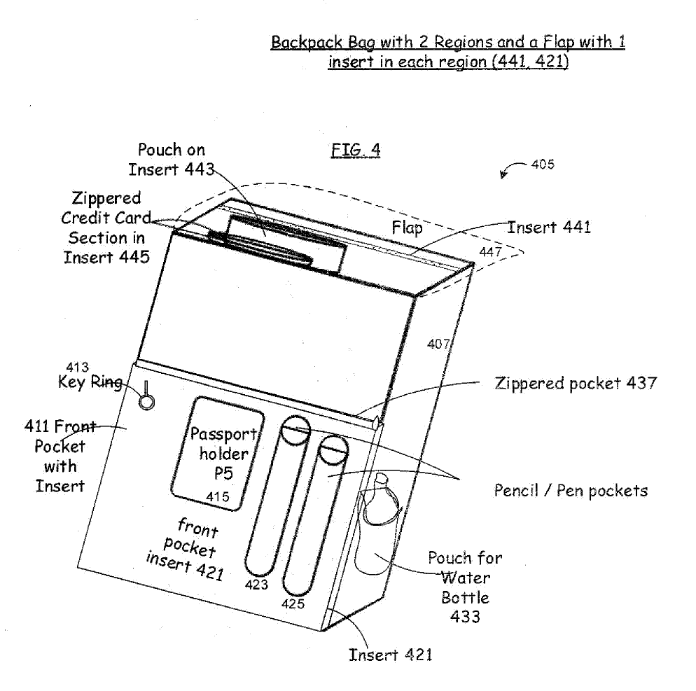

FIG. 4. is a perspective block diagram of another bag 405 for travel items which provides a first insert 441 to hold electronic devices that are charged by a power bank charger, and a second insert 421 which provides pouches for pens and pencils, keyring and a zippered EMF protected pocket for safely storing credit cards and passports. The bag 405 comprises a body/chamber 407 comprising at least one openable and closable surface, wherein the body is surrounding one interior compartment that contains the insert 441, the one interior compartment having sufficient length to host the insert which houses a powerbank portable charging device, a mobile phone, and a camera in appropriate pockets/pouches.

The insert 441 comprises at least a first carrying pouch/pocket 443 for a mobile phone, a second carrying pocket for a camera and an additional carrying pocket for the powerbank portable charging device.

The insert 441 simultaneously houses the powerbank portable charging device, the mobile phone and the camera in corresponding pockets, while the powerbank portable charging device charges both the mobile phone and the camera simultaneously. The insert 441 is removable, and can even be moved across different bags such as the bag 405. The insert 441 provides a charging cable slot through which a first charging cable passes, the powerbank portable charging device is connected to the first charging cable and to an external power outlet employing the first charging cable that travels through the charging cable slot.

The bag 405 is configured such that the first charging cable connects the powerbank portable charging device to the external power outlet, so that the bag simultaneously houses the powerbank portable charging device, the mobile phone and the camera even as the powerbank portable charging device is charged by the external power outlet and the mobile phone and the camera are at the same time charged by the powerbank portable charging device.

The bag 405 comprises a slash resistant fabric covering the body, wherein the slash resistant fabric resists horizontal, vertical and diagonal slashes made from a slashing device. In one related configuration, the slash resistant fabric comprises one or more layers of Kevlar based fabrics. In another configuration, the slash resistant fabric comprises one or more layers of Kevlar fabric strips that are woven into a mat and serves as a strong slash resistant single layer of fabric.

The insert 441 also comprises a zippered credit card section 445, which is a EMF blocking pocket configured to hold a plurality of credit cards. For example, the zippered credit card section 445 is made out of an electromagnetic field (EMF) resistant fabric which provides a faraday cage effect to protect credit cards and passports from being remotely accessed/read by unauthorized external readers/devices.

The second insert 421 provides pouches for pens 423 and pencils 425, keyring and a zippered EMF (sometimes called RFID protection too) protected pocket for safely storing credit cards and passports. The pouches for pens 423 and pencils 425 have power connectors and power cables to enable charging electronic pens or pencils that are housed in them, the charging power being supplied by the power bank charger housed in the insert 441 by means of a connecting power cable that brings power to these pouches.

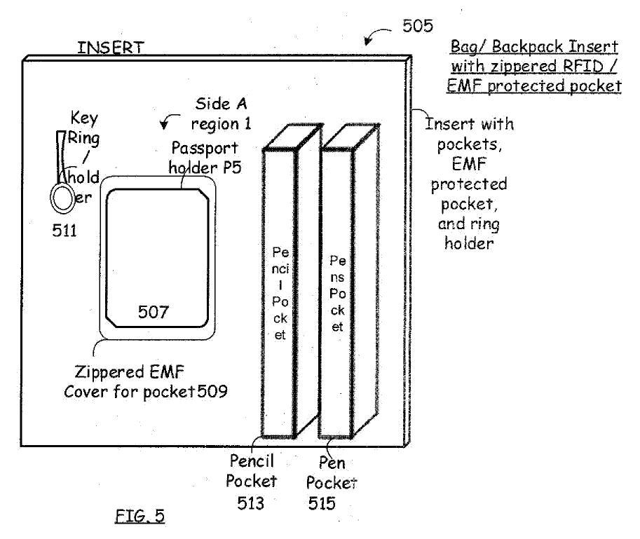

FIG. 5 is a perspective block diagram of an exemplary insert 505 which provides pouches/pockets 513, 515 for pencils and pens, a keyring 511 to hold keys, and a zippered EMF protected pocket 509 for safely storing credit cards and passports.

The zippered EMF protected pocket 509 comprises a set of credit card holders 507 for holding one or more credit cards in a faraday cage space provided by the EMF protected pocket 509. The insert 505 in one embodiment holds rechargeable stylus or electronic pens in the pencil pocket 513 and the pens pocket 515, wherein the pencil pocket 513 and the pen pocket 515 have a corresponding power cable and power connector providing a power charging capability for charging their respective electronic pens or stylus that are housed in them.

As one of ordinary skill in the art will appreciate, the terms “bag” and “travel bag,” as may be used herein, include bags used by a person, to carry during travel a collection of things to wear and personal devices to use, or a collection electrical devices to conduct one's business with.

As one of ordinary skill in the art will appreciate, the terms “connected” and “electrically connected,” as may be used herein, include direct coupling and indirect coupling via another component, element, circuit, or module where, for indirect coupling, the intervening component, element, circuit, or module does not modify the charging function but may adjust its current level, voltage level, and/or power level.

Although the present invention has been described in terms of USB based power charging of devices, other forms and techniques to charge electrical devices such as mobile phones and cameras are also contemplated.

Although the present invention has also been described in terms of “power bank chargers” or “power bank charging devices”, it must be clear that portable charging devices of all kinds are implied/covered by these terms. In general these terms which are variants of the generic term “Power bank” define devices that serve as an ‘extra battery’ or external charger for your phone or other electronic devices.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A bag, or the like, comprising:
an outer enclosure member including inwardly facing walls defining a compartment;
a removable, second inner member having a first side and a second side the first side comprising a first pouch to house a power bank charger, a second pouch to house a mobile device connected to the power bank charger employing a first cable, and a third pouch to house a camera connected to the power bank charger employing a second cable; and
attachment means mounted on said inwardly facing walls and said inner second member providing selective securement of said second member at a plurality of locations within said enclosure member.

2. The bag of claim 1 wherein the second member comprises a bottom, wherein the bottom being is collapsible, longitudinally, laterally and diagonally.

3. The bag of claim 1 wherein the first cable and the second cable are each disposed on and attached to respective retaining means on the first side of the second inner member such that they are attachable at both ends to respective electronic devices.

4. The bag of claim 1 wherein the first cable and the second cable are disposed inside guiding channels on the first side of the second inner member such that they are positioned close to the first side while also being attachable at both ends to respective electronic devices.

5. The bag of claim 1 further comprising:
the removable, second inner member comprising guiding channels through which the first cable and the second cable are disposed on the first side of the second inner member such that they are positioned close to the first side while also being attachable at both ends to respective electronic devices.

6. The bag of claim 1 further comprising a plurality of LED lights arranged in a LED display, wherein each of the plurality of LED lights when lit indicate the active presence of a corresponding electronic device in power sharing coupling with the power bank charger, wherein the corresponding electronic device is the mobile device in the second pouch, the camera in the third pouch, or another electronic device coupled to the power bank charger for charging.

7. The bag of claim 6 the LED display is disposed on the outer enclosure member.

8. A method of charging mobile devices in a travel bag, the method comprising:
inserting a bag insert into a travel bag, said bag insert comprising:
a first side having a first pouch to house a power bank charger, a second pouch to house a mobile device connected to the power bank charger employing a first cable, and a third pouch to house a camera connected to the power bank charger employing a second cable;
housing a power bank charger in the third pouch, a mobile device in the first pouch connected to the power bank charger by the first cable, and a camera in the second pouch connected to the power bank charger by the second cable.

9. The method of claim 8 further comprising:
connecting a power bank charger cable to a USB based power outlet at a first end, and to the USB based power connection on the power bank charger at a second end.

10. The method of claim 9 wherein the USB based power outlet is a wall power socket.

11. The method of claim 8 wherein the bag insert comprises a set of LEDs that are lit to indicate the charging of a corresponding electronic device by the power bank charger.

12. The method of claim 8 wherein the bag insert comprises an audio alert component that beeps when it determines one of the electronic devices have been removed from the bad for a threshold duration.

13. The method of claim 8 wherein the mobile device and the camera are charged by the power bank charger based on a priority of charging and based on a current charge level determined for each of the mobile device and the camera.

14. The method of claim 8 wherein the bag insert further comprises:
a second side having a third pouch to house an electronic tablet device connected to the power bank charger employing a third cable.

15. An insert for a bag that holds multiple electronic devices, the insert comprising:
a first side having a first pouch to house a power bank charger, a second pouch to house a first electronic device connected to the power bank charger employing a first cable, and a third pouch to house a second electronic device connected to the power bank charger employing a second cable;
a first guiding channel that positions the first cable on the first side from the first pouch to the second pouch, a second guiding channel that positions the second cable on the first side from the first pouch to the third pouch; and
a power bank charger cable that connects the power bank charger to an external power source when plugged.

16. The insert of claim 15 further comprising:
a plurality of LED lights arranged in a LED display, wherein each of the plurality of LED lights when lit indicate the active presence of a corresponding ones of the electronic devices in power sharing coupling with the power bank charger.

17. The insert of claim 16 wherein the corresponding ones of the electronic devices is a mobile device in the second pouch, a camera in the third pouch, or another electronic device coupled to the power bank charger for charging.

18. The insert of claim 15 wherein the insert is anchored to the bottom of the bag.

19. The insert of claim 15 wherein the first pouch, the second pouch and the third pouch are each zippered pockets with outlets for corresponding connectors and cables.

20. The insert of claim 15 wherein a position and a location of the first pouch, the second pouch and the third pouch are reconfigurable on the first side.
